(19) United States
(12) Patent Application Publication
(10) Pub. No.: US 2005/0079227 A1
(43) Pub. Date: Apr. 14, 2005

(54) Compositions for the treatment and prevention of plant pathogens

(76) Inventor: David Frank Tate, Kincumber (AU)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/491,553

(22) PCT Filed: Oct. 4, 2002
(86) PCT No.: PCT/AU02/01350

(30) Foreign Application Priority Data
Oct. 4, 2001 (AU) PR 8090

(51) Int. Cl. A01N 25/00; A01N 59/20

(52) U.S. Cl. 424/634

(57) ABSTRACT

An antimicrobial composition is disclosed which is particularly useful in the protection of plants against microbial attack. The composition may also be used to treat plants that are infected with microorganisms. The composition comprises in colloidal form, an antimicrobially effective amount of a product formed by the reaction in water of a water soluble cupric tetra amine salt with an acid or a salt thereof selected from the group comprising hydroxy carboxylic acids, dicarboxylic acids, hydroxy di- and tri-carboxylic acids, polyhydric dicarboxylic acids, ketonic acids and mixtures and isomers thereof; the molar ratio of the water soluble Cupric tetramine salt (as copper) to the acid or salt thereof (as carboxylate groups) being from 4:1 to 1:4; and, a pectin in an amount of 0.05 to 2.00.% w/v and having a degree of esterification of 2-20 or derivatives or mixtures thereof. Optionally, a wetting agent to promote the wetting of the plant or parts thereof by the composition, a spreading agent to promote the distribution of the composition onto the plant or parts thereof, and an adherent to promote the retention of the composition onto the plant or parts thereof may be included.

### FIELD OF THE INVENTION

This invention relates to fungicidal, bactericidal and mycocidal compositions for use in agricultural and horticultural applications and in particular to the overcoming of problems caused by fungal, bacterial and mould diseases that affect the growing and production of plants, fruit and vegetables.

### BACKGROUND TO THE INVENTION

The growth and production of plants, fruit and vegetables has long been adversely affected by microbes. This is a problem which, with the passage of time, has taken on extraordinary economic significance. To take but one example, the production of pome fruit (apples and pears) in the U.S.A. is particularly threatened by Fire Blight, a bacterial infection which occurs in its severe form only sporadically but with devastating consequences. Losses in one particular region of the US have been recently estimated at US$60-70 million in a single year.

Apart from Fire Blight, the US pome fruit industry also wrestles with the fungi known as Scab and Powdery Mildew. Some salient facts regarding Fire Blight, Scab and Powdery Mildew are as follows.

Fire Blight

The causative organism is a bacterium, Erwinia amylovore. Bacteria over-winter only in the blight strikes remaining on host trees, so continuous cutting out of infested branches is a key management practice. Some 20-50% of cankers reactivate around blossom time, as the weather warms, and ooze bacteria to their surface. This ooze is attractive to many insects, and these in turn infect the flowers. If the small fruitlets are attacked, the bacteria then spread into the adjacent branches.

At 5-14 days after the infection takes place, the symptoms become easily observable. The bacteria stream inside the tree, well ahead of the visible symptoms, moving into other more sensitive parts of the tree, such as the nearby shoot tips and susceptible root stocks.

Generally, pears are far more susceptible than apples.

Scab

The causative organism is a fungus, Venturle inequalis. Scab (also known as ‘blackspot’) is one of the most prevalent diseases of apples world-wide. The fungus over-winters on infected leaves on the floor of the orchard. Spores are produced on these leaves and are discharged during rainy periods. The spores first lodge on the underside of young leaves and if the trees are wet enough for the spores to germinate, infection occurs. This ‘primary scab’ can generate secondary infection in 12-20 days. Fruit may become infected at any time in its development from blossom to maturity with very early infections sometimes resulting in blighting of blossoms and dropping of young fruit Apples that are severely infected are misshapen, and the scab will cause deep cracks.

Powdery Mildew

The causatve organism is a fungus, Podosphaere leucotricha. The fungus over-winters as fungal strands (mycellum) in dormant blossom and shoot buds produced and infected the previous seasorl When the buds break dormancy, the new leaves and flowers are infected by the fungus. The powdery fungal growth produced on infected tissue consists of thousands of tiny spores (conidia) which are responsible for secondary spread and infection, these being disseminated through the orchard In wind currents and water splashes. Secondary infection cycles may continue until susceptible tissue is no longer available. Since leaves are most susceptible soon after emergence, infection of new leaves may occur as long as shoot growth continues. Fruit Infection occurs from pink to bloom.

Conidia can withstand hot, dry periods for many weeks, so once be infection is established, it is a potential threat throughout the season. Powdery Mildew causes whitish lesions on curled or folded leaves, stunted whitish-grey growth evident on dormant shoots, and fruit russeting.

Economic damage occurs in the form of aborted blossoms, reduced fruit finish quality, reduced vigour, poor return bloom and yield of bearing trees, and poor growth of nonbearing trees.

The prior art provides a variety of fungicidal and mycocidal compositions. However, concerns about the potentially adverse effect on the environment through the use of such compositions as well as diminishing effectiveness suggests that it would be desirable to be able to provide effective fungicides and mycocides with a reduced environmental impact. In addition, it would be desirable for such compositions to avoid the public health concerns such as are evident over the use of antibiotics such as terramycin which is used in the treatment of Fire Slight as well as known carcinogens such as DMIs (demethylation inhibitors) which are used to treat scab and powdery mildew. In addition, many fungi have developed resistance to DMIs. Consequently, there application is normally restricted to three times in a season.

### SUMMARY OF THE INVENTION

The present inventor has found that it is possible to provide a copper-based composition, where the copper is in a particular form, whereby an antimicrobially effective amount of copper is released in response to a pathogenic Infection which occurs on a plant, fruit or vegetable.

Accordingly, in a first aspect the present invention consists in an aqueous antimicrobial composition in colloidal form for application to a plant or a part thereof comprising, an antimicrobially effective amount of a product formed by the reaction in water of a water soluble cupric tetra amine salt with an acid or a salt thereof selected from the group comprising hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin in an amount of 0.05 to 2.00% and having a degree of esterification of 2-20 or derivatives or mires thereof; and optionally, one or more of:
a wetting agent to promote the wetting of the plant or parts thereof by the composition;
a spreading agent to promote the distribution of the composition onto the plant or parts thereof, and
an adherent to promote the retention of the composition onto the plant or parts thereof.

In a second aspect the present invention further consists in a method of protecting a plant or a part thereof from microbial infection, comprising applying an effective amount of a composition which includes an antimicrobially effective amount of a product formed by the reaction In water of a water soluble cupric tetra amine salt with an acid or a salt thereof selected from the group comprising hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin in an amount of 0.05 to 2.00% and having a degree of esterification of 2-20 or derivatives or mixtures thereof; and optionally, one or more of:
a wetting agent to promote the wetting of the plant or pads thereof by the composition;
a spreading agent to promote the distribution of the composition onto the plant or parts there; and
an adherent to promote the retention of the composition onto the plant or parts thereof; to a plant or a part thereof.

In a third and related aspect, the present invention still further consists in a method of treating a microbial infection in a plant or a part thereof, comprising applying an effective amount of a composition which includes a mycocidally, bactericidally and/or fungicidally effective amount of a product formed by the reaction in water of a water soluble cupric tetra amine salt with an acid or a salt thereof selected from the group comprising hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin in an amount of 0.05 to 2.00% and having a degree of esterification of 2-20 or derivatives or mixtures thereof; and optionally, one or more of:
a wetting agent to promote the wetting of the plant or parts thereof by be composition;
a spreading agent to promote the distribution of the composition onto the plant or parts thereof, and
an adherent to promote the retention of the composition onto the plant or parts thereof;
   to a plant or a part thereof provided that microorganism remains on the surface, stomata or pores of the plant or part thereof.

In a fourth aspect, the present invention sill further consists in the use of a copper-based composition to either treat a plant or part thereof which is infected by a microorganism on the surface, stomate or pore thereof, or to protect a plant or part thereof from mould, bacteria and/or fungus infection, the g composition comprising an antimicrobially effective amount of a product formed by the reaction in water of a water soluble cupric tetra amine salt with an acid or a salt thereof selected from the group comprising hydroxy carboxylic acids, dicarboxylic acids, hydroxy dl- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin in an amount of 0.05 to 2.00% and having a degree of esterification of 2-20 or derivatives or mixture thereof; and optionally, one or more of,
a wetting agent to promote the wetting of the plant or parts thereof by the composition;
is a spreading agent to promote the distribution of the composition onto the plant or parts thereof; and
an adherent to promote the retention of the composition onto the plant or parts thereof.

In a fifth aspect the present invention provides an antimicrobial composition which when dispersed in water forms a collold for application to a plant or a part thereof comprising,

an antimicrobially effective amount of a product formed by the reaction in water of a water soluble cupric tetra amine salt with an acid or a salt thereof selected from the group comprising hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin having a degree of esterification of 2-20 or derivatives or mixtures thereof; and optionally, one or more of:
a wetting agent to promote the wetting of the plant or parts thereof by the composition;
a spreading agent to promote the distribution of the composition onto the plant or parts thereof; and
an adherent to promote the retention of Fe composition onto the plant or parts thereof.

As used in this specification, be terms “antimicrobial” and “antimicrobially” refers to at least one of algicidal, bactericidal, fungicidal and mycocidal activity and “microorganism” refers to a least one of algae, fungi, moulds and bacteria.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In addition, it should be noted that all concentrations given in this specification are % w/v, unless otherwise stated.

Disclosure of the Invention

Although not wishing to bound by theory, the present inventor believes that the effectiveness of the compositions of the invention results from the action of the enzymes released by the fungus, bacteria, mould or algae when infecting the plant or part thereof. In the case of pectolytic enzymes, enzymatic action acts to break down the pectin thereby releasing the copper molecule which is toxic towards the fungus, bacteria, mould or algae. Note that some moulds, bacteria, algae and fungi do not release pectolytic enzymes but release other enzymes such as sucrases or hydrolases which extract the copper from the pectin using chemical forces of attraction.

This invention may be used in relation to a variety of plants and the parts thereof. A nonexhaustive list includes those that are used in horticulture; fruit trees; plants that are cultivated for flowers; fruit vegetables; crops; vines, and trees and shrubs.

Application of the compositions of the invention to plants or parts thereof may be accomplished by spraying in a conventional manner. In these circumstances, usually all parts of the plant would be covered, such as foliage, blossoms, grain and fruit. Of course it will be appreciated that if plants or parts thereof are to be protected from infection, that application of the composition must take place at a time prior to the infection period. This will vary depending on, for example, the nature of the plant, the season and its location.

In those applications where the parts of a plant are to be protected, such as potatoes to be stored for seeding purposes, treatment may be accomplished by immersing the harvested potatoes in the composition.

Although the invention may be used to protect plants or parts thereof from a variety of bacterial, mould and/or fungal infections or to treat plants or parts thereof that are infected, a non-exhaustive list of pathogens and diseases that may be treated are set out in the table below.

| Crop | Disease | Microorganism |
|---|---|---|
| Apples | Bacterial canker | Pseudomonas syringae |
| | Canker | Nectria galligena |
| | Scab | Venturica inaequalis |
| | | Phyllosticta briardi |
| | Powdery Mildew | Podospheraera leucotricha |
| | Fire Blight | Erwinia amylovora |
| Apricot | Shot hole | Bacillus mesentericus |
| | ″ | Xanthomonas pruni |
| | ″ | Coryneum beyerinekii |
| | Freckle | Venturia carpophila |
| | ″ | Stigmina carpophila |
| Almonds | As in peaches, | As in peaches, |
| | nectarines | nectarines |
| Avocado | Anthracnose | Collectotrichum gloesporioides |
| | ″ | Glomerella cingulata |
| Banana | Sigatoka leaf spot | Cercospora musae |
| | Leaf speckle | |
| | Cordana | |
| | Cigar end rot | |
| Barley | Leaf scald | |
| Beans | Chocolate spot | Botraytis cinerea |
| | Halo blight | Pseudomonas |
| | | syringae.v.phaseolicola |
| | Halo blight | Rhizoctonia solani |
| | ″ | Sclerotium rolsii, S. sclerotiorum |
| | ″ | Colletotrichum lindemuthianum |
| | Common blight | Xanthomonas campestris.v. |
| | | phaseoli |
| | Bacterial brown spot | Pseudomonas syringae.v. |
| | | syringae |
| | Rust | Uromyces sp. |
| Beetroot | Downy mildew | Peronspora farinosa |
| | Rust | Uromyces betae |
| Berryfruit | Grey mould | Botrytis cinerea |
| Brassicas | Black rot | Xanthomonas campestris |
| | Peppery leaf spot | Pseudomonas syringe.v. |
| | | maculicola |
| | Transplant rot | Rhysoctonia sp. |
| | Downy mildew | |
| | Ring spot | |
| Carrots | Leaf spot | Cercospora sp. |
| | ″ | Alternaria sp. |
| Celery | Soft rot | Erwinia carotovora |
| | Leaf spot | Septoria apicola |
| | ″ | Alternaria sp. |
| Coffee | Rust | Hemilleia vastatrix |
| Citrus | Brown rot | Phytophthora citrophthora |
| | Septoria spot | Septoria sp. |
| | Canker | Xanthomonas citri |
| | Mal secco | Deuterphoma tracheiphila |
| | Melanose | Diaphortha citri, Phomopsis citri |
| | Greasy spot | Mycosphaerella citri |
| | Anthracnose | Gloeosporium limetticolum |
| | Scab | Elsinoe fawcettii, Sphaceloma sp. |
| | Black spot | Gulgicardia citricarpa |
| | ″ | Phoma citricarpa |
| | Brown spot | Alternaria Sp. |
| | Sooty mold | Gloeodes pornigena |
| Cucurbits | Angular leaf spot | Psuedomonas |
| | | syringea.bachrymans |
| | Bacterial leaf spot | Xanthomonas |
| | | campestris.cucurbitae |
| | Grey mold | Botrytis cinerea |
| | Brown rot | Phytophthora Sp. |
| | Sour rot | |
| | Fusarium rot | Fusarium oxysphorum |
| | Downy mildew | Plasmosphora Sp, |
| | | Peronsphora Sp |
| Grapes | Grey mould | Botrytis cinerea |
| | Powdery mildew | Uncinula necator |
| | Downy mildew | Plasmosphora viticola |
| | Bacterial canker | Agrobacterium tumefaciens |
| | Dying arm | Phomopsis Sp. |
| | ″ | Pestalotiopsi Sp. |
| | ″ | Botryospaeria Sp. |
| | ″ | Greenaria Sp. |
| | ″ | Gloeosporium ampelophagum |
| | ″ | Pseudopeziza tracheiphila |
| | Cutting infection | Xanthomonas ampelina |
| | Black spot | Elsinae ampelina |
| Guava | | Macrophoma |
| | | allahabadensis.pycnidia |
| | | Aspergillus niger |
| | | Phytophthora Sp. |
| Kiwifruit | | Botrytis cinerea |
| Okra | Powdery mildew | Erysippe cichoracearum |
| Onions | White rot | |
| Allium Sp | Black rot | |
| | Downy mildew | Peronosphora destructor |
| Mangoes | Anthracnose | Colletrotrichium gloesporioides |
| | Fruit drop | Fusarium oxysporum |
| Peaches | Shot hole | Stigmina carpophila |
| Stone fruit | ″ | Bacillus mesentericus vulgatis |
| | ″ | Xanthomonas pruni |
| | Shot hole | Coryneum beyerinekii |
| | ″ | Rhizopus Sp |
| | Leaf curl | Taphrina deformans |
| | Bacterial blight | Pseudomonas mors-prunorum |
| | Blossom blight | Monilinia fructicola |
| | Brown rot | Monilinia frustigena |
| | ″ | Monilinia laxa |
| Passionfruit | Brown spot | Alternaria Sp. |
| Lettuce | Bacterial leaf spot | Xanthomonas campestris.vitians |
| | Anthracnose | Marssonina panattoniona |
| | Downy mildew | Bremia lactucae |
| | Drop | Sclerotinia sclerotiorum |
| Lychee | Parasitic algae | |
| Parsnips | Leaf spot | Septoria Sp. |
| Peas | Asochyta blight | Ascochyta Sp. |
| | Bacterial blight | Pseudomonas syringae.syringae |
| Potatoes | Early blight | Alternaria solani |
| | Late blight | Phytophthora infestans |
| Pears | Scab | Venturia firina |
| | Fire blight | Erwinia amylavora |
| Pecan | | Phytophthora Sp. |
| Rhubarb | Crown rot | Phytophthora parasitica |
| | Downy mildew | Peronsphora jaaplana |
| Silverbeet | Rust | Uromyces betae |
| Spinach | Downy mildew | Peronspora farinosa |
| Strawberry | Leaf Spot | Mycosphaerella fragariae |
| | Powdery mildew | |
| | Downy mildew | Plasmopara Sp. |
| | Grey mold | Botrytis cinerea |
| | Black spot | |
| Tobacco | Leaf spot | Psuedomonas syringae.v.tabaci |
| Tomatoes | Target spot | Alternaria solani |
| Capsicums | Septoria leaf spot | Septoria Sp. |
| | Sclerotinia rot | Sclerotinia sclerotiorium |
| Tomatoes | Grey mold | Botrytis cinerea |
| Solanum Sp | | |
| | Late blight | Phytophthora infestans |
| | Anthracnose | Colletotrichum capsici |
| | Bacterial spot | Xanthomonas |
| | | campeastris.vesicatoria |
| | Bacterial speck | Pseudomonas syringae.tomato |
| | Bacterial canker | Corynebacterium michiganese |
| Walnuts | Blight | Xanthomonas caompestris |
| | | v.juglans |

In addition, certain Arthropods are repelled by the present invention, namely:
Snails—Helix asperse
Slugs—Limax Sp. The mechanism of this action appears to be the drying effect of the compositions of the invention on the pectolytic enzymes produced by snails and slugs.

The compositions of the invention include a water soluble cupric tetra amine-salt which is reacted with an acid or a salt thereof. Examples of such cupric tetra amine salts include the sulfate (Cu(NH)₄.SO₄), the carbonate (Cu(NHs)₄.CO₃) and the hydroxide (Cu(NH₃)₄.OH). These salts are of course known and can be manufactured In accordance with known procedures.

The cupric tetre amine salt is reacted with an acid or a salt thereof. These acids or salts thereof are selected from the group comprising hydroxy carboxylic acids, dicarboxylic acids, hydroxy di- and tri-carboxylic acids, polyhydric dicarboxylic acids, ketonic acids and mixtures and isomers thereof. Suitable examples of these acids include lactic acid, glycollic, hydracrylic acid, sarcolactc acid, oxalic acid, malonic acid, glutaric acid, malonic acid, fumaric acid, ascorbic acid, tartaric acid, citric acid, saccharic acid, mucic acid, mannonic acid, pyruvic acid and levulic acid. Of these acids, tartaric, citric and malic are preferred as well as their salts.

Reaction of the cupric tetra amine salt with the acid or salt thereof is accomplished in aqueous media with the molar ratio of the water soluble cupric tetramine salt (as copper) to the acid or salt thereof (as carboxylate groups) being from 4:1 to 1:4, preferably about 1:1.

There is some conjecture as to the Identity or structure of the reaction product between the cupric tetra amine salt and the acid. For example, in Russian Journal Of Inorganic Chemistry, 23, 779-781 (1978), it is stated that whilst there is some evidence that the reaction product with citric acid is a binuclear complex, the authors conclude that based on electron spin resonance studies, complexes of this type were unlikely to be binuclear. This is consistent with the inventor's understanding that it is important to ensure that during formation of the reaction product the acid chelation of the copper does not displace all of the amine groups to form the binuclear complex. In the prior art, binuclear complexes were found to be insoluble. The present inventor has postulated that since these complexes are insoluble, they are largely ineffectve against plant pathogens.

The pectins are defined as a group of compounds formed from the protopectin of unripe fruits which, on hydrolysis, form pectic acid. In the aqueous compositions of the invention, the pectin is included in an amount of from 0.05 to 2.00%. Preferably, the pectin is included in an amount of from 0.05 to 0.20%.

Within the scope of the invention are included pectins having a degree of esterification of 2-20 and derivatives or mixtures thereof. Preferably the degree of esterification is 2-16, most preferably 4-15, more particularly 9-13.

In the context of this specification “degree of esterification” may also be understood to mean “degree of methoxylation”. Some specific examples of pectins falling within the scope of this invention include sodium polypectate, potassium polypectate and ammonium polypectate. Also failing within the scope of pectins or derivatives thereof are pectates, pectinates and the product of acid derived pectin demeoxylation-polygalacturonic acid.

Amongst the adjuvants which are optionally included in the compositions of the invention are a wetting agent to promote the wetting of the plant or parts thereof by the composition;
a spreading agent to promote the distribution of the composition onto the plant or parts thereof; and
an adherent to promote the retention of the composition onto the plant or parts thereof.

Preferred adherents are water soluble acrylic polymers such as poly (methacrylate) and poly(butylacrylate). Preferably non ionic surfactants are Included with the acrylic polymers. A variety of non ionic surfactants may be used provided that they are low foaming. Such non ionic surfactants include nonylphenoxypoly(ethyleneoxy)ethanol.

To ensure that the compositions of the Invention are stable, the pH will usually be a minimum of 5.5, preferably 7.6-12, most preferably 7.5-10.

Preparation of Compositions of the Invention

In preparing a fungicidal composition in accordance with the invention, the cupric tetra amine is first prepared conventionally. It is then mixed in aqueous solution with the selected acid or salt thereof, the acid being mixed in the ratio of 4:1 to 1:4 acid to amine salt The reaction product is then added to, or to it is added, a solution of the selected pectin or derivative thereof. The resultant product is an opaque/colloidal liquid which may be described as “a pectically colloided acid chelated cupric tetra amine”.

In implementation of the method of treatment according to the invention, the foregoing composition may be added to water at between 500 mL to 5 litres-100 litres of water. Rain fastness may be improved by the incorporation of a polyacrylate sicker in the order of 0.12-0.5% of the solution to be sprayed. Acrylates and some of the acids (gluconic and mucic acids) are also useful as wetters and spreaders.

### MODES FOR CARRYING OUT THE INVENTION

In order to better understand the nature of his invention, the invention will now be further described with reference to specific illustrative examples.

### EXAMPLE 1

a. 160 g Cu(NH₃)₄.CO₃
b. 80 g Glutaric acid
c. 100 g Na polypectate
   Components (a) and (b) are initially dissolved in 1.5 litres of water, a mild reaction ensuing to form a reaction product Separately thereafter, this reaction product is added to component (c) which is dissolved in 3.5 litres of water.

This 5 litre batch of the composition of the invention may be diluted to a 100 litre batch for application to the crops to be treated as indicated above.

### EXAMPLE 2

a. 80 g Cu(NH₃).$0₄
b. 40 g Tartaric acid
c. 100 g K polypectate
   This example is prepared in like fashion to Example 1.

### EXAMPLE 3

a. 120 g Cu(NH₃)₄.OH
b. 60 g Glycollic acid
c. 200 g NH₄ polypectate
   This example is prepared in like fashion to Example 1.

### EXAMPLE 4

a. 50 g Cu(NH₃)₄.NO₃
b. 75 g Mucic acid
c. 200 mL Polygalacturonic add dissolved in 2-10 litres of water

This example details the preparation of a relatively water free composition for later reconstitution into water. The advantage of such a composition is that it avoids the necessity of transporting large amounts of water.

Components (a) and (b) are initially dissolved in 1.5 litres of water, a mild reaction ensuing to form a reaction product. Component (c) is then added to the reaction product to remove water, an equal amount of propyl alcohol is added to precipitate the composition. The precipitate may then be removed by filtration. In use, the relatively water-free composition is dissolved in an appropriate amount of water prior to use, with an adherent, spreader agent and wetting agent being added in appropriate amounts.

Alternatively, component (b) may be directly added to an ammonia solution in a stoichiometric amount to form ammonium mucate. Sufficient additional ammonia is added to ensure that when cupric nitrate is dissolved in the solution, the stoichiometric ratio of 4:1, ammonium to copper ions is preserved. Preparation then proceeds as previously outlined.

### EXAMPLE 5

a. 160 g Cu(NH₃)₄.SO₄
b. 80 g Citric acid
c. 100 g Na polypectate
   15 g Ammonium Mucate

This example details the preparation of a concentrate for later reconstitution into water. The advantage of such a composition is that it avoids the necessity of transporting large amounts of water.

Components (a) and (b) are initially dissolved in 1 lite of water, a mild reaction ensuing to form a reaction product. The sodium polypectate and ammonium mucate are dissolved separately to components (a) and (b) in 1-5 litres of water at 70° C. using a high speed mixer. The reaction product is then added to the sodium polypectate and ammonium mucate solution with stirring.

After thorough mixing, the product is packed for later reconstitution into 100 litres of water. On reconstitution, a non ionic surfactant such as Teri (registered trade mark of Orica Umited), an example being Teric 150, and an adherent such as that disclosed In GB 974841 are added in appropriate amounts in the range 0.1-0.25% of the total solution. It should be noted that the non ionic surfactant may be incorporated during the preparation of the composition. In this way, the non ionic surfactant assists in promoting dispersion during reconstitution.

The use of mucic acid is believed to be advantageous as it improves the interface between the applied composition and the cuticle of the plant

### EXAMPLE 6

a. 80 g Cu(NH₃).SO₄
b. 40 g Malic acid
c. 50 g Na polypectate
   10 g Gluconic acid

As described in Example 5, components (a) and (b) are dissolved in 300 mL of water, a mild reaction ensuing to form a reaction product concentrate. In this example, the sodium polypectate and gluconic acid are dry mixed to form component (c). This component (c) is vigorously mixed with about 60 mL of water and about 0.1-1.0 mL of non-ionic surfactant at 70° C. to form a very partially hydrated thick paste. Concentrate and paste may be incorporated to produce a cream. This cream will require prehydration using a small amount of water prior to use and will be applied at the rate of around 500 mL cream to 100 litres of water.

### EXAMPLE 7

In this example, a dry concentrate for later rehydration may be prepared as follows.

A comminuted fruit or vegetable marc is dissolved in a caustic solution of NaOH, KOH or ammonia to a pH of 10-12, preferably about 11, at a temperature between 12 and 15° C. The Na, K or NH₄ ions replace calcium ions in the pectates. This results in the pH dropping as calcium ions are released, thus requiring the addition of additional alkali to maintain the pH in the desired range, preferably about 11.

Once the pectate is In solution, the solution Is filtered to remove the solid remnants of the marc. To the solution is added sufficient potassium, sodium and/or ammonium citrate to precipitate any residual calcium. Addition of citrate is terminated once the pH of the solution has reached 7.5.

Sufficient of a reaction product, such as that of Example 5, is added to the solution to bring the pH of the solution to 7.5-8.0 and the copper-concentration to an effective level.

Water is removed from the solution through the addition of ethanol at about 100%. Wetting agents, spreading agents and adherents may then be added as required and the resultant product dried and comminuted to pass a 100 mesh screen. Packing of the products so-obtained is in air tight containers.

### EXAMPLE 8

In a method of treatment experiment carried out with Bartlett pears, the Example 3 product was compared with several known treatment agents. Treatment was carried out with conventional hand held pump spray equipment. The results indicated superiority of Example 3 over the conventional treatment agents.

The present inventor believes that the compositions of this invention are advantageous over prior compositions for a number of reasons: These include:

The copper is substantially all in solution, thereby offering a maximal level of toxicity towards pathogens;
The compositions of the invention are relatively non-toxic towards most microorganisms that are beneficial. This is to be contrasted with the prior art copper compositions which are generally toxic to both beneficial and pathogenic microorganisms; and
The compositions of the invention have relatively low phytotoxicity. This is particularly advantageous when the compositions are used on fruits.

It will be appreciated by persons skilled in the art that numerous variations and/or modifications may be made to the invention as show in the specific embodiments without departing from the spirit or scope of the invention as broadly described. The present embodiments are, therefore, to be considered in all respects as illustrative and not restrictive.

1. An aqueous antimicrobial composition in colloidal form for application to a plant or a part thereof comprising, an antimicrobially effective amount of a product formed by the reaction in water of a water soluble cupric tetra amine salt with an acid or a salt thereof selected from the group consisting of hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin in an amount of 0.05 to 2.00% w/v and having a degree of esterification of 2-20 or derivatives or mixtures thereof; and optionally, one or more of;
a wetting agent to promote the wetting of the plant or parts thereof by the composition;
a spreading agent to promote the distribution of the composition onto the plant or parts thereof; and
an adherent to promote the retention of the composition onto the plant or parts thereof.

2. An aqueous antimicrobial composition according to claim 1 wherein the cupric tetra amine salt is selected from the group consisting of (Cu(NH₃)₄.SO₄), (Cu(NH₃)₄.CO₃) and (Cu(NH₃)₄.OH).

3. An aqueous antimicrobial composition according to claim 1 wherein the acid or salt thereof is selected from the group consisting of lactic acid, glycollic acid, hydracrylic acid, sarcolactic acid, oxalic acid, malonic acid, glutaric acid, malic acid, fumaric acid, ascorbic acid, tartaric acid, citric acid, saccharic acid, mucic acid, mannonic acid, pyruvic acid, levulic acid, including salts, isomers and mixtures thereof.

4. An aqueous antimicrobial composition according to claim 1 wherein the acid or salt thereof is selected from the group consisting of tartaric acid, citric acid, malic acid and salts and mixtures thereof.

5. An aqueous antimicrobial composition according to claim 1 the molar ratio of the water soluble cupric tetramine salt (as copper) to the acid or salt thereof (as carboxylate groups) being about 1:1.

6. An aqueous antimicrobial composition according to claim 1 wherein the pectin is in an amount of 0.05 to 0.2% w/v.

7. An aqueous antimicrobial composition according to claim 1 the pectin having a degree of esterification of 2-16.

8. An aqueous antimicrobial composition according to claim 7 the pectin having a degree of esterification of 4-15.

9. An aqueous antimicrobial composition according to claim 7 the pectin having a degree of esterification of 9-13.

10. An aqueous antimicrobial composition according to claim 1 including an adherent.

11. An aqueous antimicrobial composition according to claim 10 wherein the adherent comprises water soluble acrylic polymers.

12. An aqueous antimicrobial composition according to claim 11 including non ionic surfactants.

13. An aqueous antimicrobial composition according to claim 1 wherein the pH of the composition is at least 5.5.

14. An aqueous antimicrobial composition according to claim 13 wherein the pH of the composition is 7.5 to 12.

15. An aqueous antimicrobial composition according to claim 14 wherein the pH of the composition is 7.5 to 10.

16. A method of protecting a plant or a part thereof from microbial infection, comprising applying an effective amount of a composition which includes an antimicrobially effective amount of a product formed by the reaction in water of a water soluble cupric tetra amine salt with an acid or a salt thereof selected from the group consisting of hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric to tetramine salt (as copper) to the acid or salt thereof (as carboxylate groups) being from 4:1 to 1:4; and
a pectin in an amount of 0.05 to 2.00% and having a degree of esterification of 2-20 or derivatives or mixtures thereof; and optionally, one or more of:
a wetting agent to promote the wetting of the plant or parts thereof by the composition;
a spreading agent to promote the distribution of the composition onto the plant or parts thereof; and
an adherent to promote the retention of the composition onto the plant or parts thereof;
to a plant or a part thereof.

17. A method of treating a microbial infection in a plant or a part thereof, comprising applying an effective amount of a composition which includes a mycocidally, bactericidally and/or fungicidally effective amount of a product formed by the reaction in water of a water soluble cupric tetra amine salt with an acid or a salt thereof selected from the group consisting of hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin in an amount of 0.05 to 2.00% and having a degree of esterification of 2-20 or derivatives or mixtures thereof; and optionally, one or more of:
a wetting agent to promote the wetting of the plant or parts thereof by the composition;
a spreading agent to promote the distribution of the composition onto the plant or parts thereof; and
an adherent to promote the retention of the composition onto the plant or parts thereof;
to a plant or a part thereof provided that microorganism remains on the surface, stomate or pores of the plant or part thereof.

18. Use of a copper-based composition to either treat a plant or part thereof which is infected by a microorganism on the surface, stomate or pore thereof, 10 or to protect a plant or part thereof from mould, bacteria and/or fungus infection, the composition comprising an antimicrobially effective amount of a product formed by the reaction in water of a water soluble cupric tetra amine salt with an acid or a salt thereof selected from the group comprising consisting of hydroxy carboxylic acids, dicarboxylic acids, hydroxy di- and tri-carboxylic acids, polyhydric dicarboxylic acids, ketonic acids and mixtures and isomers thereof, the molar ratio of the water soluble cupric tetramine salt (as copper) to the acid or salt thereof (as carboxylate groups) being from 4:1 to 1:4; and
a pectin in an amount of 0.05 to 2.00% and having a degree of esterification of 2-20 or derivatives or mixtures thereof; and optionally, one or more of:
a wetting agent to promote the wetting of the plant or parts thereof by the composition;
a spreading agent to promote the distribution of the composition onto the plant or parts thereof; and
an adherent to promote the retention of the composition onto the plant or parts thereof.

19. An antimicrobial composition which when dispersed in water forms a colloid for application to a plant or a part thereof comprising, an antimicrobially effective amount of a product formed by the reaction in water of a water soluble cupric tetra amine salt with an acid or a salt thereof selected from the group consisting of hydroxy carboxylic acids, dicarboxylic acids, hydroxy di- and tri-carboxylic acids, polyhydric dicarboxylic acids, ketonic acids and mixtures and isomers thereof; the molar ratio of the water soluble cupric tetramine salt (as copper) to the acid or salt thereof (as carboxylate groups) being from 4:1 to 1:4; and
a pectin having a degree of esterification of 2-20 or derivatives or mixtures thereof; and optionally, one or more of:
a wetting agent to promote the wetting of the plant or parts thereof by the composition;
a spreading agent to promote the distribution of the composition onto the plant or parts thereof; and
an adherent to promote the retention of the composition onto the plant or parts thereof.
